(19) United States
(12) Patent Application Publication
(10) Pub. No.: US 2009/0196315 A1
(43) Pub. Date: Aug. 6, 2009

(54) PULSED LASER OSCILLATOR WITH VARIABLE PULSE DURATION

(76) Inventors: Louis Cabaret, Plessis-Saint-Benoist (FR); Cyril Drag, Saint arnoult en Yvelines (FR)

Correspondence Address: ARENT FOX LLP, 1050 CONNECTICUT AVENUE, N.W., SUITE 400, WASHINGTON, DC, 20036, US

(21) Appl. No.: 12/299,208

(22) PCT Filed: May 5, 2007
(86) PCT No.: PCT/FR07/51208

§ 371 Date: Apr. 3, 2009

(30) Foreign Application Priority Data
May 3, 2006 (FR) 0651575

(51) Int. Cl. H01S 3/10; H01S 3/00; H01S 3/13

(52) U.S. Cl. 372/25; 372/38.07; 372/29.021

(57) ABSTRACT

The present invention relates to the field of pulsed laser oscillators. It relates to a pulsed laser oscillator (15) for emitting a laser pulse, including a laser cavity (15), said laser cavity including a laser medium (4) able to be pumped by pump radiation emitted by at least one pump radiation source (5) and to emit laser radiation, said laser cavity (15) including seal means (7) able to seal said cavity for a period of sealing, characterized in that said seal means (7) are electro-optical seal means, and in that said seal means are able to be powered by a supply voltage, so that the duration of the pulse emitted is modified when the value of the supply voltage is modified.

The present invention relates to the field of pulsed laser oscillators.

Pulsed laser oscillators comprising a laser cavity are known, with said laser cavity including a laser medium able to be pumped by a pump radiation emitted by at least one pump radiation source and seal means able to seal said cavity.

Such lasers are known as triggered laser or “Q-switch laser”. The seal means are currently called quality factor switches or Q-switches. In such a laser, initially, a laser crystal is pumped by a pump diode, whereas the seal means are closed and prevent the back streaming of the laser wave into the crystal. This causes a population inversion inside the crystal, but the lasing of the laser medium does not happen since there is no back streaming. Whereas the seal means still close the cavity, the laser crystal is charged with energy by pumping. The seal means are then opened to allow the back streaming of the wave after the reflection on one end of the cavity. The process of amplification by a stimulated emission can then begin. Because of the important quantity of energy stored in the laser medium, the laser signal generated is very short, and a short pulse is obtained at the oscillator outlet.

In such known devices, the duration of the laser pulse at the oscillator output is a priori constant.

Now, it is advantageous to supply a laser oscillator for which the duration of the obtained laser pulse can vary. As a matter of fact, the adjustment of the pulse duration is interesting for adapting the characteristics of the pulses to the type of the phenomena to be studied. Then, for pulsed lasers having a fixed pulse duration, if it is desired to modify the pulse duration to study a new phenomenon, it is necessary to get a new laser having the required pulse duration. This situation is of course one drawback of the fixed pulse duration lasers.

Pulsed lasers with variable pulse duration also exist.

A first known solution to perform such an adjustment of the pulse duration consists in causing the pumping power of the laser medium to vary. As a matter of fact, when it is desired to cause this pumping power to vary, the quantity of energy stored within the laser crystal varies, and the pulse duration also varies.

However, this solution has important drawbacks. As a matter of fact, a variation in the pumping power causes a variation of the thermal conditions in the laser medium and consequently a modification of the thermal lens that the latter produces inside the cavity. Even though the laser cavity is configured so as to be little sensitive to the variations of the thermal lens in the form of a dynamically stable cavity, a large amplitude of variation in the pulse duration, controlled by the pumping power, causes a modification of the spatial characteristic of the beam and a variation of the energy emitted which can even lead to the stoppage of the laser emission.

In the laser sources with a high rate of repetition (from 1 kHz to 100 kHz), this drawback is remedied by adjusting the pulse duration by causing the repetition rate to vary. If the laser medium is pumped in a continuous operating condition and if the interval between two pulses is less than the life duration of the upper level of the laser transition, the change in the repetition rate modifies the energy stored and consequently the pulse duration.

The pump power is constant indeed, but such a device has the drawback that the repetition rate is not constant.

Another solution for performing such an adjustment in the pulse duration consists in controlling the Q-switch within the quick cavity. Such a solution is for example described in the application for the American patent US-A-2001/0021205 which discloses a pulsed laser oscillator comprising a laser cavity, said laser cavity comprises a laser medium able to be pumped by a pump radiation emitted by at least one pump radiation source and seal means able to seal said cavity.

Such application teaches how to use an acousto-optical Q-switch connected to an electronic unit generating a high frequency wave which can be modulated within the laser resonator. The Q-switch and more particularly the duration of the opening and the closing thereof is then controlled by this high frequency wave.

However, the utilisation of an acousto-optical Q-switch has certain drawbacks.

A first drawback consists in that the duration of the opening which is related to the dimension of the beam in the switch is generally long and thus short pulse durations can hardly be obtained.

A second drawback consists in the fact that if it is desired to increase the energy stored with a view to reducing the duration of pulses, the free running operating conditions very easily appears since the closing rate of the acousto-optical Q-switch is not correct.

The publication “High-energy high-brightness Q-switched Tm 3+ doped fibre laser using an electro-optic modulator” by El-Sharif et al, is also known. In this publication, a laser cavity comprising an amplifying medium in the form of a doped fibre, produces multiple pulses through an effect of post-lasing in triggered conditions. In order to reduce the laser emission to only one pulse per firing, it is disclosed to modify the voltage applied to the electro-optical modulator. However, in the above-mentioned publication, the duration of pulses is not modified when the supply voltage is modified.

The present invention aims at remedying such drawbacks.

A first aim of the invention is thus to supply a pulsed laser with a variable pulse duration.

Another aim of the invention consists in supplying a pulsed laser with variable pulse duration without requiring any modification of the pumping power of the laser crystal.

Another aim of the invention consists in supplying a pulsed laser oscillator using no acousto-optical Q-switch.

At least one of these aims is reached by the invention which relates, according to a first aspect, to a pulsed laser oscillator for emitting a laser pulse including a laser cavity, said laser cavity including a laser medium able to be pumped by a pump radiation emitted by at least one pump radiation source and to emit a laser radiation, said laser cavity including seal means able to seal said cavity for a period of sealing,

characterised in that said means are electro-optical seal means and in that said seal means are able to be supplied by a supply voltage, so that the duration of the emitted pulse is modified when the value of the supply voltage is modified.

In this laser cavity, the seal means include for example electro-optical crystals.

So, it is possible to cause the duration of the laser pulses of the pulsed laser oscillator to vary by modifying the supply voltage of the electro-optical Q-switch.

It should be noted that the closing rate of an electro-optical switch is much better than that of an electro-acoustic such as described for example in the document US-A-2001/0021205.

According to an embodiment of the invention, in the above-mentioned pulsed laser oscillator, said laser cavity includes a coupling polariser able to reflect said laser rotation with a reflecting power, the coupling polariser being so arranged that said reflecting power is modified when the value of the supply voltage is modified.

So, the reflecting power of the coupling polariser may vary as a function of the supply which results in the variation of the laser pulse duration.

In addition, in order to supply a pulsed laser oscillator having a correct temperature insensitivity, a correct flux hardness and good electro-optical coefficients in the above-mentioned pulsed laser oscillator, said seal means may include a first RbTiOPO₄ crystal having a first axis and a second RbTiOPO₄ crystal having a second axis, the first axis and the second axis being crossed.

In addition, in the above-mentioned pulsed laser oscillator, in order to guarantee a correct insensitivity of the oscillator to outside interferences, said laser cavity is sealed by a first mirror and a second mirror, said first mirror and said second mirror defining a stability parameter, said stability parameter being between 0.4 and 0.6 and being preferably 0.5.

The invention also relates to a device comprising a pulsed laser oscillator such as previously described, said supply means able to supply said variable supply voltage to said seal means and means for controlling the seal supply control means able to modify said supply voltage so as to modify the duration of the laser pulse emitted by the oscillator.

The supply means include for example a voltage generator and seal supply control means include for example a potentiometer.

The invention also aims at supplying a pulsed laser oscillator with variable pulse duration while keeping a substantially constant energy.

As a matter of fact, one of the drawbacks of the pulsed oscillator with variable pulse duration is that the variation in the pulse duration involves a variation in the laser energy. This is more particularly the case if the variation in the pulse duration is obtained by causing the pumping power to vary since this pumping power affects both the pulse duration and the energy emitted.

To remedy such drawback, the above-mentioned device may include pump supplying means able to supply a pump current to said pump radiation source, said pump radiation having an energy, said energy being a function of said pump current, said device including pumping control means able to cause said pump current to vary.

The pulsed laser oscillator according to the invention includes two adjustment parameters which can be modified independently from one another, which makes it possible to adjust the pulse duration thanks to the seal supply control means and to adjust the pump energy by means of the pump control means. An appropriate adjustment of both parameters which can be modified independently from one another makes it possible to keep the energy of the immediate laser pulse substantially constant.

More particularly, said pulsed laser oscillator is able to emit a laser signal, wherein said supply voltage and said pump current are so selected that the laser energy is substantially constant.

In addition, when the seal means are voltage supplied, it is advantageous that the voltage to be applied is not too high. This makes it possible to avoid more particularly the utilisation of complex and costly supply means.

Another aim of the invention thus consists in supplying a pulsed laser oscillator with variable pulse duration by switching a voltage supplied Q-switch without the voltage to be applied to the Q-switch being too high.

Now, it is known per se that the voltage to be applied to a Q-switch and a pulsed laser oscillator depends on a quarter wave blade positioned between the laser medium and the seal means.

In a conventional way, in order to extract the maximum of energy from the laser medium, it is desired that the gain of the laser medium is as high as possible while preventing the oscillator to be operated in a free running operating condition which would affect the quality of the beam and the flux hardness of the optical components, Now, within the scope of the present invention which is to obtain an oscillator with variable pulse duration, this gain constraint is no longer present.

Thus, the above-mentioned laser cavity has a laser threshold and said laser cavity may include polarisation means able to modify a polarisation condition of said laser radiation prior to said coupling polariser, said polarisation means being so arranged that said laser cavity is positioned just under said laser threshold, at a loss limit of the free running operating condition.

Thus, the voltage to be applied to the Q-switch may be low and the supply means may be simple and not very costly.

The invention also relates to a method for varying the duration of the pulse emitted by the pulsed laser oscillator including a laser cavity, said laser cavity including a laser medium able to be pumped by a pump radiation emitted by at least one pump radiation source and to emit a laser radiation and electro-optical seal means, said method characterised in that it includes steps consisting in:
supplying a supply voltage to said seal means;
modifying said supply voltage so as to modify the duration of the pulse emitted by the pulsed laser oscillator.

According to one embodiment, said laser cavity may include a coupling polariser able to reflect said laser rotation with a reflecting power wherein said reflecting power is modified when said supply voltage is modified.

According to a particular embodiment, in the above-mentioned method, said pump radiation has pump energy and said method includes steps consisting in:
supplying a pump current to said pump radiation source,
causing said pump current to vary
   wherein said pump energy is a function of said pump current.

Again according to one embodiment of the invention, in the above-mentioned method, said pulsed laser oscillator is able to generate a laser signal having laser energy and said duration of sealing and said pump energy being so selected that said laser energy is substantially constant.

According to another embodiment of the invention too, in the above-mentioned method, said laser cavity has a laser threshold, said laser cavity including polarisation means able to modify a polarisation condition of the laser radiation prior to said coupling polariser, said method including possibly steps consisting in:
supplying a pump current of said pump radiation source, said pump current being fixed to a maximum value;
positioning said laser cavity in a free running operating condition;
adjusting said polarisation means so as to position said cavity just under said laser threshold at a loss limit of the free running operating condition;
applying a supply voltage to said seal means;
   causing said supply voltage and said pump current to vary independently from one another.

Other aims and advantages of the present invention will appear upon reading the following description while referring to the appended drawing wherein:

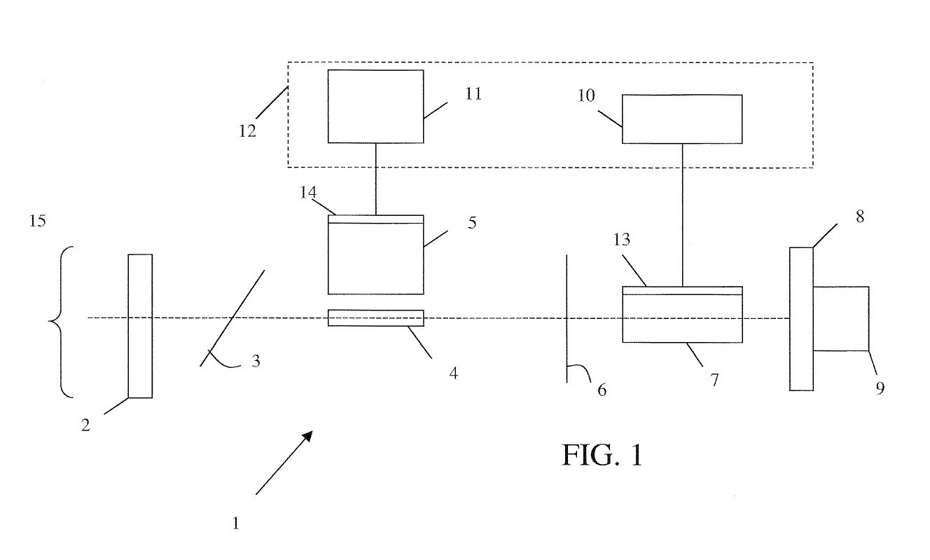

FIG. 1 is a diagram illustrating an exemplary pulsed laser oscillator according to the invention;

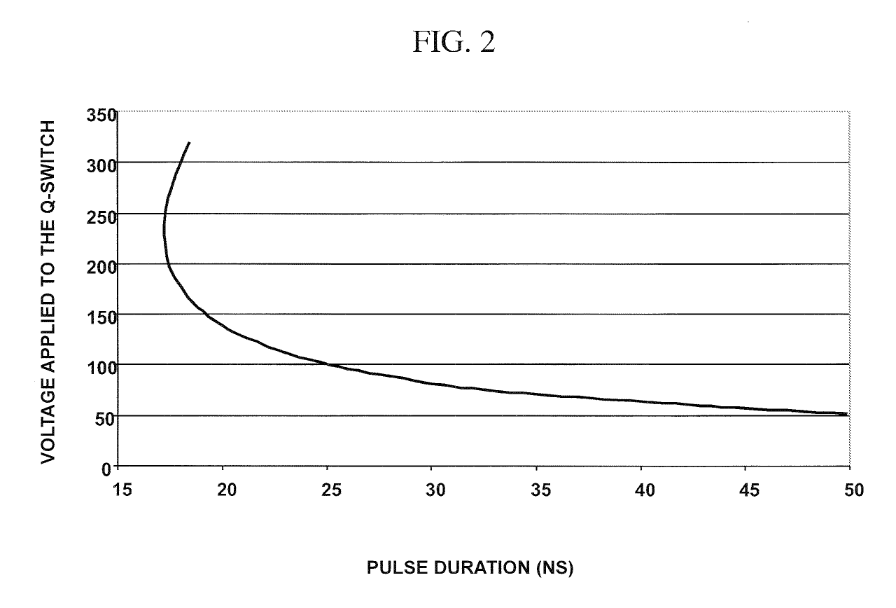

FIG. 2 is a diagram showing the evolution of the triggering voltage as a function of the duration of the pulsed laser oscillator of FIG. 1.

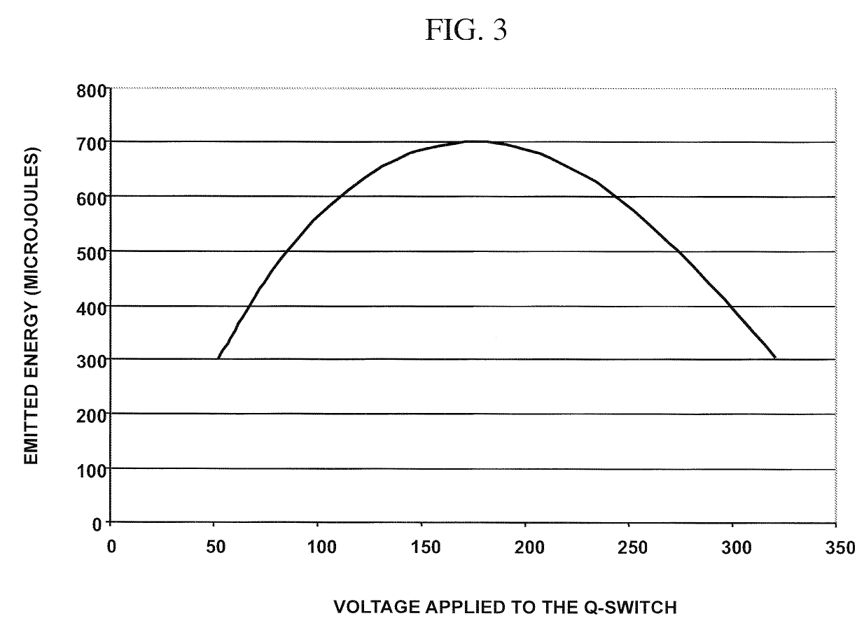

FIG. 3 is a diagram showing the evolution of the energy emitted by the laser cavity prior to the adjustment of the voltage and the current;

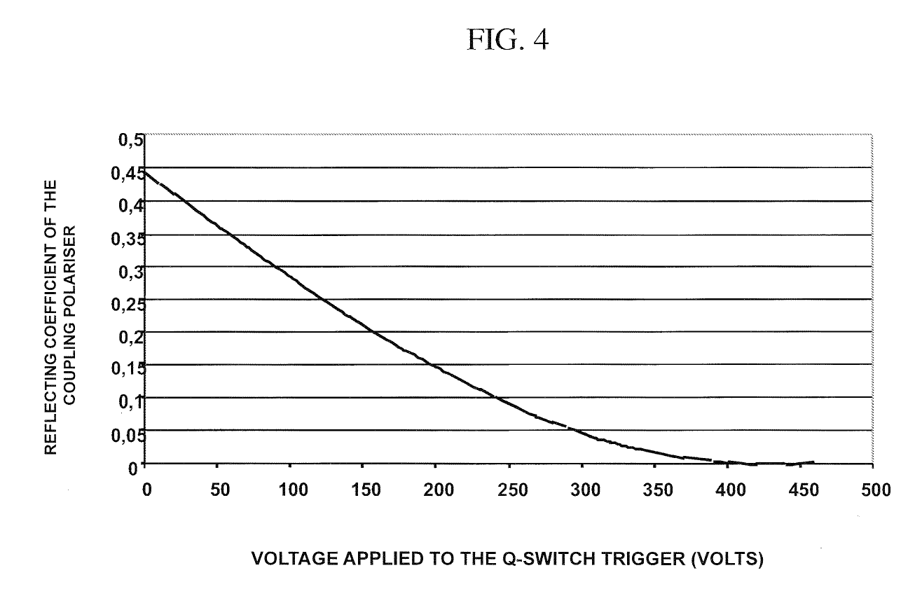

FIG. 4 is a diagram illustrating the reflecting coefficient of the coupling polariser as a function of the voltage applied to the seal means of the pulsed laser oscillator of FIG. 1 for one orientation of the quarter wave blade of 0.4 rad;

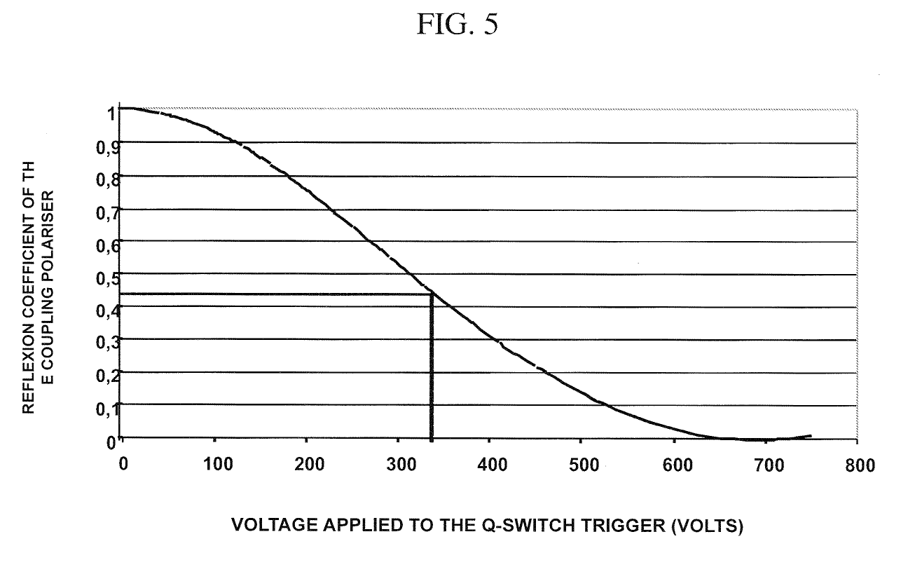

FIG. 5 is a diagram illustrating the reflecting coefficient of the coupling polariser as a function of the voltage applied to the seal means of a pulsed laser oscillator with a usual adjustment of the quarter wave blade of π/4 radian;

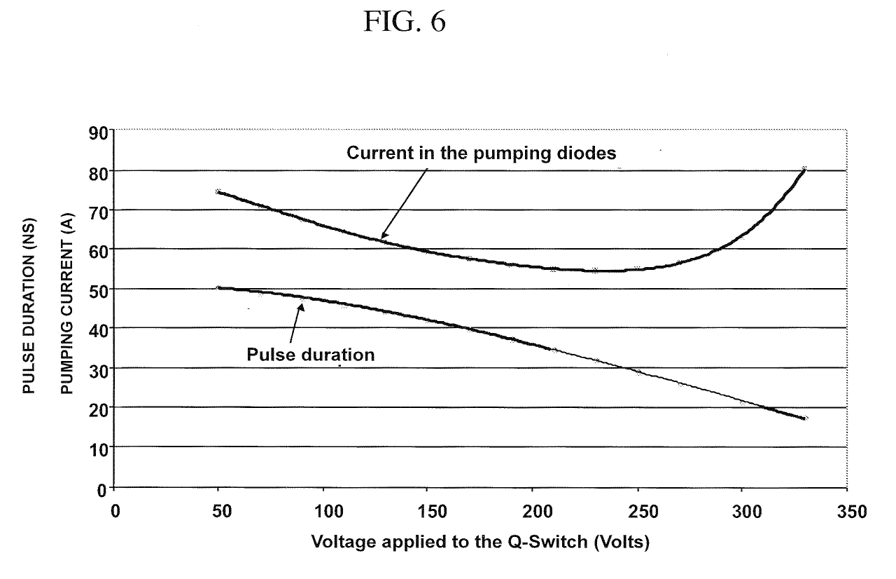

FIG. 6 is a diagram illustrating, for a constant energy of 300 microjoules, the duration of the pulse emitted when the current injected to the pumping diodes and the voltage applied to the seal means vary.

A device 1 according to the invention is illustrated in FIG. 1 and includes a pulsed laser oscillator 15 in the form of a laser cavity 15. It also includes supply means 12 for the pulsed oscillator elements. The supply means 12 include current supply means 11 and voltage supply means 10.

The laser cavity 15 includes a laser medium 4. The laser medium 4 is a neodymium-doped crystal currently called YAG, or yttrium aluminium garnet having the Y₃Al₅O₁₂ composition.

The laser cavity 15 has an effective length of 170 mm. It is sealed by two mirrors 2, 8 which totally reflect the laser radiation for a wavelength of 1,064 nm. The first mirror 2 is planar and the second mirror 8 is concave with a radius of curvature of 2,000 mm, so that the cavity 15 is stable with a beam diameter of about 0.9 mm on the planar mirror 2.

A diaphragm having a diameter of 1.2 mm may be positioned just in front of the mirror 2 so as to select the Gaussian mode TEM₀₀ of the cavity 15.

According to a variation, if the thermal stresses of the laser medium 5 are high, the laser cavity 15 can also be configured so as to meet the criterion of insensitivity to the variations of the thermal lens, i.e. a stability parameter between 0.4 and 0.6, preferably close to 0.5.

The Nd:YAG crystal laser 4 is cut in the form of a half cylinder 15 mm in length and 4.4 mm in diameter.

A stack of three laser diodes 5 strips supplied by a current generator 11 pumps this crystal through the cylindrical face.

The pump radiation which has not been absorbed during the first passage in the laser crystal is reflected by the plane rear face which has received a reflecting treatment for the pumping wavelength at 808 nm. The laser beam which is formed in the cavity is amplified in the pump area when following a path parallel to the axis of the half cylinder.

The device for coupling the laser light to the outside of the cavity is composed of a polarising blade 3 inclined at Brewster's angle. The reflecting power of this polarising blade depends on the polarisation condition of the incident light.

A quarter wave blade 6 having means for rotating about the axis of the cavity enables the cavity to be operated either in a free running operating condition or in a triggered operating condition, according to the orientation of the axes of the blade.

The cavity is triggered thanks to a pair of electro-optical crystals 7 currently called RTP or RbTiOPO₄. The RTP crystals 7 are matched in length and their axes are crossed so that, without any applied voltage, their global birefringence is null. In this configuration, they are simply equivalent to a phase blade and, in addition, their polarisation properties are almost insensitive to temperature. To obtain the optimal conditions for the triggering, the axes X and Z of the RTP crystals are oriented at 45° with respect to the polarisation plane defined by a coupling polariser 3. The triggering electric field is applied along the axis Z of each of the crystals, thanks to gold electrodes 13 positioned on the orthogonal faces at Z. A pulse generator 10 delivers a pulsed voltage which can be adjusted between 0 and 500V synchronized with the front edge of the diode pumping current. The voltage value is controlled for example by a potentiometer 10.

According to a possible mode of injected operation, the concave mirror 8 is mounted on a piezoelectric ceramic 9 used for controlling the optical length of the cavity. The injected frequency may remain in resonance with a mode of the cavity.

The optimisation of the cavity is obtained in several steps so as to obtain pulses of variable duration with a low triggering voltage.

During a first step, the cavity mirrors 2 and 8 are conventionally adjusted without any voltage being applied to the electro-optical crystals 7, by acting on the means for adjusting in rotation the mirrors 2 and 8. During such step of adjustment, a current slot, 100 microseconds in duration, is injected into the pumping diodes 5.

During a second step, the optical axis of the quarter wave blade 6 is oriented so as to obtain maximum laser energy in a running free operating condition, i.e. while optimising the coupling in the cavity. As a matter of fact, when turning the quarter wave blade 4, the polarisation condition of the beam incident on the coupling polariser 3 varies and consequently the effective reflecting part of the coupling polariser also varies.

During the third step, the diodes current is increased up to the maximum authorised by the supply 11 or up to the maximum recommended by the diodes manufacturer, i.e. for example up to 80 amperes.

During a fourth step, the quarter wave blade is turned by an angle α so that the laser passes just under the laser threshold. The angle is for example fixed at 0.4 radian. The angular mark which determines α corresponds to the alignment of the optical axis of the quarter wave blade 4 in the polarisation plane defined by the plane of incidence of the coupling 3.

The operation of the laser is then restored, but this time, in triggered running, if a voltage front is applied to the RTP crystals 7, at the end of the pumping slot. As a matter of fact the voltage front edge consists a polarisation condition so that the reflecting power of the coupling polariser 3 makes it possible for the laser to pass above the laser threshold. FIG. 4 illustrates this behaviour wherein, without any voltage applied, the laser threshold corresponds to a reflecting power of the coupling polariser of approximately 44%. The voltage which is applied to the RTP crystals 7 results in the reduction of the reflecting power and thus a loss on coupling. The laser cavity 15 can thus emit.

By adjusting the supply voltage by means of a potentiometer 10 and the electrodes 13, the laser emission is not only restored, but then the pulse duration varies. This result is illustrated in FIG. 2. In this figure, it can be seen that the pulse duration can be adjusted between more than 50 ns and 17 ns, when the supply voltage varies between 50 volts and 220 volts. The supply voltage is fixed as a function of the pulse duration to be obtained. Once this supply voltage is fixed, possibly further to a modification, as a function of the pulse duration to be obtained, the supply voltage remains constant as a function of time during each pumping and emission cycle. Further to the emission, the supply voltage can be modified again.

The same adjustment could be obtained according to the usual adjustment mode of the quarter wave blade with the drawback of requiring a higher pulsed voltage, however. According to this usual adjustment mode, the maximum extinction rate of the seal means is searched for the duration of the pumping.

The quarter wave blade is thus oriented at an angle α=π/4 radian, so that after a travel to and back from the seal means, the polarisation has turned by π/2 radian. The coupling polariser 3 is then totally reflecting and the laser cavity 15 is totally blocked. This configuration is illustrated in FIG. 5. To return to the conditions of FIG. 3, i.e. to reach the laser threshold corresponding to a reflecting power of 44%, a supply voltage of approximately 330 volts will previously be applied to the crystals 7. The adjustment of the pulse duration is then carried out as previously mentioned while causing the voltage to vary between approximately 330 volts and 600 volts.

While preparing the laser cavity 15 as previously disclosed, laser pulses having a variable duration are obtained, but the energy is not constant as illustrated in FIG. 3.

By acting independently on the voltage of the RTP crystals 7 and on the current of the pumping diodes 5, it is possible to keep the energy emitted constant. This is illustrated in FIG. 6, wherein the current in the pumping diodes and the duration of the pulse emitted as a function of the tension applied to the Q-switch 7 for a constant energy of 300 microjoules are shown. Both functions are represented with a correct approximation by degree three polynomials for the pulse duration and degree five polynomials for the current of the diodes 5. The applicant determined a polynomial equal to:

2.10⁻¹⁰x⁵−1.10⁻⁷x⁴+4.10⁻⁵x³−0.0048x²+0.1059x+77,213

for the current curve, and a polynomial equal to:

6.10⁻⁷x³−0.0005x²+0.0018x+51,255

for the pulse duration curve.

Such functions are, of course, compatible with a computerised driving of the supply device 12.

1. A pulsed laser oscillator for emitting a laser pulse, including a laser cavity, said laser cavity including a laser medium able to be pumped by a pump radiation emitted by at least one pump radiation source and to emit a laser radiation, said laser cavity including seal means able to seal said cavity for a period of sealing, wherein said seal means are electro-optical seal means, and said seal means are able to be powered by a supply voltage, so that the duration of the pulse emitted is modified when the value of the supply voltage is modified.

2. A pulsed laser oscillator according to claim 1, wherein said laser cavity includes a coupling polariser able to reflect said laser rotation with a reflecting power, the coupling polariser being so arranged that said reflecting power is modified when the value of the supply voltage supplying the seal means is modified.

3. A pulsed laser oscillator according to claim 1 or 2, wherein said seal means include a first RbTiOPO4 crystal having a first axis and a second RbTiOPO4 having a second axis, the first axis and the second axis being crossed.

4. A pulsed laser oscillator according to claim 1 or 2, wherein said laser cavity has a laser threshold, said laser cavity including polarisation means able to modify a polarisation condition of said laser radiation prior to said coupling polariser, said polarisation means being so arranged as to position said laser cavity just under said laser threshold, at a loss limit of the free running operating conditions.

5. A pulsed laser oscillator according to claim 1, wherein said laser cavity is closed by a first mirror and a second mirror, said first mirror and said second mirror defining a stability parameter, said stability parameter being between 0.4 and 0.6 and being preferably 0.5.

6. A device including a pulsed laser oscillator according to claim 1, said device comprising supply means able to supply said supply voltage to said seal means, and seal supply control means able to modify said supply voltage.

7. A device according to claim 6 comprising pump supply means able to supply a pump current to said pump radiation source, said pump radiation having an energy, said energy being a function of said pump current, said device comprising pumping control means able to cause said pump current to vary.

8. A device according to claim 7, wherein said pulsed laser oscillator is able to emit a laser signal and wherein said supply voltage and said pump current are so selected that said laser energy is substantially constant.

9. A method for modifying the duration of a pulse emitted by a pulsed laser oscillator including a laser cavity, said laser cavity including a laser medium able to be pumped by a pump radiation emitted by at least one pump radiation source and to emit a laser radiation, and electro-optical seal means, said method comprising:
supplying a supply voltage to said seal means;
modifying said supply voltage so as to modify the duration of the pulse emitted by the pulsed laser oscillator.

10. A method according to claim 9, wherein said laser cavity includes a coupling polariser able to reflect said laser radiation with a reflecting power and wherein said coupling polariser is so arranged that said reflecting a power is modified when the value of the supply voltage supplying the seal means is modified.

11. A method according to claim 9 or 10, wherein said pump radiation has a pump energy and said method includes steps consisting in:
supplying a pump current to said pump radiation source,
causing said pump current to vary
wherein said pump energy is a function of said pump current.

12. A method according to claim 9 or 10, wherein said pulsed laser oscillator is able to emit a laser signal and wherein said supply voltage and said pump current are so selected that said laser energy is substantially constant.

13. A method according to claim 9 or 10, wherein said laser cavity has a laser threshold, said laser cavity including polarisation means able to modify a polarisation condition of said laser radiation prior to said coupling polariser including steps consisting in:
supplying a pump current to said pump radiation source, said pump current being fixed at a maximum value;
positioning said laser cavity in a free running operating condition;
adjusting said polarisation means so that said cavity is positioned just under said laser threshold, at a loss limit of the free operating condition;
applying a supply voltage to said seal means;
causing said power voltage and said pump current to vary independently from one another.

14. A method according to claim 11, wherein said pulsed laser oscillator is able to emit a laser signal and wherein said supply voltage and said pump current are so selected that said laser energy is substantially constant.

15. A method according to claim 11, wherein said laser cavity has a laser threshold, said laser cavity including polarisation means able to modify a polarisation condition of said laser radiation prior to said coupling polariser including steps consisting in:
supplying a pump current to said pump radiation source, said pump current being fixed at a maximum value;
positioning said laser cavity in a free running operating condition;
adjusting said polarisation means so that said cavity is positioned just under said laser threshold, at a loss limit of the free operating condition;
applying a supply voltage to said seal means;
causing said power voltage and said pump current to vary independently from one another.

16. A method according to claim 12, wherein said laser cavity has a laser threshold, said laser cavity including polarisation means able to modify a polarisation condition of said laser radiation prior to said coupling polariser including steps consisting in:
supplying a pump current to said pump radiation source, said pump current being fixed at a maximum value;
positioning said laser cavity in a free running operating condition;
adjusting said polarisation means so that said cavity is positioned just under said laser threshold, at a loss limit of the free operating condition;
applying a supply voltage to said seal means;
causing said power voltage and said pump current to vary independently from one another.
